(19) United States
(12) Patent Application Publication
(10) Pub. No.: US 2006/0014869 A1
(43) Pub. Date: Jan. 19, 2006

(54) Dye cleaner, and method for cleaning colorant delivery systems

(75) Inventors: Kelly Stinson, Cannonsburg, PA (US); Robert W. Merrill, McMurray, PA (US)

Correspondence Address: LANXESS CORPORATION, 111 RIDC PARK WEST DRIVE, PITTSBURGH, PA, 15275-1112, US

(73) Assignee: LANXESS Corporation

(21) Appl. No.: 11/174,986

(22) Filed: Jul. 5, 2005

Related U.S. Application Data
(60) Provisional application No. 60/587,707, filed on Jul. 14, 2004.

(51) Int. Cl. C08K 5/17

(52) U.S. Cl. 524/239

(57) ABSTRACT

A composition that includes (a) a chealant component; (b) a polyaspartic acid component; and (c) a disulfonated diphenyl component; such that the chealant component, the polyaspartic acid component, and the disulfonated diphenyl component are present in sufficient amounts so that when the composition treats a colorant delivery system containing deposits, the deposits are removed from the system. The invention also relates to methods for making and using such a composition.

### BACKGROUND

Colorant delivery systems are systems in which colorants are added during an industrial process, e.g., a papermaking process. Colorant delivery systems clog during use and that such clogs cause problems to the users.

Unfortunately, ordinary colorant delivery system cleaners have disadvantages. For instance, colorant delivery system cleaners in the industry are generally very caustic and, as such, are difficult to work with and hazardous. Further, ordinary colorant system cleaners are sometimes not very effective, which results in off-spec products or unplanned production downtimes for their respective users.

For the foregoing reasons, there is a need to develop an improved colorant delivery system cleaning system.

### SUMMARY

The invention relates to a composition that includes (a) a chealant component; (b) a polyaspartic acid component; and (c) a disulfonated diphenyl component; such that the chealant component, the polyaspartic acid component, and the disulfonated diphenyl component are present in sufficient amounts so that when the composition treats a colorant delivery system containing deposits, the deposits are removed from the system. The invention also relates to methods for making and using such a composition.

These and other features, aspects, and advantages of the present invention will become better understood with reference to the following description and appended claims.

### DESCRIPTION

The invention is based on the remarkable discovery that a specific combination of chemicals, colorant delivery systems can be cleaned more effectively and with materials that are substantially less caustic (hazardous) than known materials.

As used herein, the term “colorant” includes direct dyes, basic colorants, acid dyes and pigments.

Other than in the operating examples or where otherwise indicated, all numbers or expressions referring to quantities of ingredients, reaction conditions, etc., used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations.

The composition of the invention generally includes (a) a chealant component; (b) a polyaspartic acid component; and (c) a disulfonated diphenyl component; such that the chealant component, the polyaspartic acid component, and the disulfonated diphenyl component are present in sufficient amounts so that when the composition treats a colorant delivery system containing deposits, the deposits are removed from the system.

The chelating agent component generally includes one or more transition-metal selective sequestrants or “chelating agents”, e.g., iron and/or copper and/or manganese chelating agents, provided that such materials are compatible or suitably formulated. Chelating agents suitable for use herein can be selected from the group consisting of aminocarboxylates, iminodisuccinates, hydroxycarboxylates (especially citrates), phosphonates (especially the aminophosphonates), polyfunctionally-substituted aromatic chelating agents, phosphates, and mixtures thereof. In one embodiment, sodium iminodisuccinate is used. Such materials are commercially available. Although polyaspartic acid, and their respective salts are considered cheleants sometimes, for the purposes of this application, the term “chelant component” does not include polyaspartic acids. A suitable sodium iminodisuccinate material for this invention includes BAYPURE® CX 100, available from Bayer Chemicals Corporation.

The chelating agent component is generally present in an amount ranging from 20 to 100 weight %, based on the total weight of the composition.

The polyaspartic acid component can be any polyaspartic acid, which when used in conjunction with the components of the invention, produces a composition that, upon treating a colorant delivery system containing deposits, the deposits are removed from the system. Suitable polyaspartic acids are especially polyaspartic acid homopolymers and their salts, as described in WO 96/31 554, incorporated herein by reference in its entirety. Preference is given to using the sodium salt and the ammonium salt of polyaspartic acids, which are biodegradable and ecologically safe substances. It is of course also possible to use all other salts and/or water-soluble copolymers of polyaspartic acids and their salts. It is likewise possible to use the anhydride of polyaspartic acids, polysuccinimide (PSI). The above-mentioned polyaspartic acids and/or derivatives thereof are present individually or in mixtures in amounts of at least 5% by weight. The sodium salt of the polyaspartic acids is preferably used in the cleaning compositions according to the invention. The polyaspartic component is generally present in an amount ranging from 0 to 50 weight %, based on the total weight of the composition. Polyaspartic acid materials are commercially available. A suitable polyaspartic acid material can be obtained from Bayer Chemicals Corporation under the name BAYPURE® DS 100.

The disulfonated diphenyl component generally includes sodium mono disulfonated diphenyl, didecyl disulfonated diphenyl, and/or combinations thereof.

The disulfonated diphenyl component is generally present in an amount ranging from 1 to 50, weight %, based on the total weight of the composition.

In one embodiment, instead of disulfonated diphenyl component, it is possible to use suitable surfactants such as sodium octyl sulfonate, sodium lauryl sulfate, sodium ethyl hexyl sulfate, sodium lauryl ether sulfate, sodium alkylated (mono and didecyl) diphenyl oxide disulfonates, sodium alkylated (mono and didodecyl) diphenyl oxide disulfonates, and certain ethylene oxide, propylene oxide block copolymers having low HLB (Hydrophile Lipophile Balance) values and low foam characteristics. A suitable disulfonated diphenyl material can be obtained from Pilot Chemicals under the name CALFAX® 10L-45

The pH of the composition can vary, depending on application. The composition generally has a pH ranging from 9 to 12. Products currently used to clean delivery systems have higher pH's and are caustic or are solvent based and are flammable.

The solids weight % of the composition can vary, depending on the application. The composition generally has a solids weight % ranging from 30 to 50 weight %, based on the total weight of the composition.

The specific gravity of the composition can vary, depending on the application. The composition generally has a specific gravity ranging from 1.25 to 1.5, based on the total weight of the composition.

The appearance of the composition is generally a visual appearance of a clear amber colored liquid.

To make the composition, the invention provides a method that involves adding to a vessel (a) a chealant component; (b) a polyaspartic acid component; and (c) a disulfonated diphenyl component; such that the chealant component, the polyaspartic acid component, and the disulfonated diphenyl component are present in sufficient amounts so that when the composition treats a colorant delivery system containing deposits, the deposits are removed from the system. As such, in one embodiment, the invention involves a method that involves (a) adding a sodium iminodisuccinate component to a vessel,(b) adding, with stirring, a polyaspartic acid sodium salt component, (c) adding, to the vessel, a disulfonated diphenyl component selected from the group consisting of sodium mono disulfonated diphenyl, didecyl disulfonated diphenyl, and combinations thereof; and (d) stirring the mixture for a sufficient amount of time to mix the resulting mixture product is well mixed and uniform; such that the sodium iminodisuccinate component, the polyaspartic acid sodium salt component, and the disulfonated diphenyl component are present in sufficient amounts so that when the composition treats a colorant delivery system containing deposits, the deposits are removed from the system.

In use, the invention provides a method that cleans a colorant delivery system without the problems ordinarily found in conventional methods. In one embodiment, the invention provides a method for cleaning a colorant delivery system that involves treating a colorant containing a colorant with the composition that includes (a) a chealant component; (b)a polyaspartic acid component; and (c)a disulfonated diphenyl component; such that the chealant component, the polyaspartic acid component, and the disulfonated diphenyl component are present in sufficient amounts so that when the composition treats a colorant delivery system containing deposits, the deposits are removed from the system. In one embodiment useful in papermaking application, the composition includes (a) a sodium iminodisuccinate component; (b) a polyaspartic acid sodium salt component; and (c) a disulfonated diphenyl component selected from the group consisting of sodium mono disulfonated diphenyl, didecyl disulfonated diphenyl.

The delivery system that can be treated with the composition of the invention can be any delivery system that forms deposits, such that deposits are removed when the system is treated with the composition of the invention.

Generally, a delivery system includes at least one component that comes in direct contact with a neat or diluted colorant. Examples of suitable delivery systems include but are not limited to metal piping, stainless steel components, filtering devices, valves, metering pumps, dilution tanks, and combinations thereof.

The colorants that the composition of the invention can treat can include a wide variety of colorants. For instance, in papermaking applications, examples of suitable colorants include but are not limited to acid dyes, direct dyes and mixtures of both categories of dyes. Dyes of these categories may be found in the Color Index. For instance, acid dyes are given on pages 1003-1560 of the Color Index, Volume 1, 3rd edition, The Society of Dyers and Colorists and American Association of Textile Chemists and Colorists. Some typical examples of acid dyes which are particularly suitable for coloring paper are the yellow acid dyes C.I. 13,065 and 47,035, the orange dyes C.I. 13,090, C.I. 15,575 and C.I. 15,510 and the red acid dyes C.I. 45,380 and C.I. 15,620. Direct dyes are given on pages 2007-2477 of the Color Index, Volume 2. Typical direct dyes usually employed to color paper are the yellow direct dyes C.I. 29,000, C.I. 24,895, C.I. 13,950, C.I. 29,025, C.I. 40,000, C.I. 40,001 and C.I. 24,890, the orange direct dyes C.I. 40,215, C.I. 40,265 and C.I. 29,156, the red direct dyes C.I. 29,175, C.I. 28,160, C.I. 22,120 and C.I. 25,410, the blue direct dyes C.I. 23,155 and C.I. 24,340 and the violet direct dye C.I. 25,410. Other suitable dyes the invention can be used in are described, inter alia, in the textbook entitled “Kunstliche organische Farbstoffe und ihre Zwischenprodukte” (Synthetic organic Dyes and Intermediates thereof) by H. R. Schweizer, Springer Verlag Berlin (1964), pages 481 to 495. Suitable dyes among those described are in particular azo dyes, especially disazo or trisazo dyes, which contain water-solubilising anionic sulfonic acid groups. Optical brighteners which can likewise be used in the process according to the invention belong in general to the styryl and stilbene series, particularly to the class comprising distyrylarylenes, diaminostilbenes, ditriazolylstilbenes, phenylbenzoxazolylstilbenes, stilbenenaphthotriazoles and dibenzoxazolylstilbenes. Foremost of interest in this connection are optical brighteners of the distyrylbiphenyl class or of the bistriazinylaminostilbene class, which contain water-solubilising anionic sulfonic acid groups, especially bis-(phenylamino-dialkylamino-s-triazinyl)-stilbenedisulfonic acids and bis-(phenylaminomorpholino-s-triazinyl)-stilbenedisulfonic acids.

The invention provides previously unavailable advantages. For instance, since the composition of the invention is non-caustic and non-flammable, the composition of the invention is generally easier to work with than ordinary compositions. Further, the composition of the invention, and its corresponding methods, is very effective, thereby enhancing benefits to users, e.g., papermakers.

Although the present invention has been described in detail with reference to certain preferred versions thereof, other variations are possible. Therefore, the spirit and scope of the appended claims should not be limited to the description of the versions contained therein.

What is claimed is:

1. A composition comprising:
(a) a chealant component;
(b) a polyaspartic acid component; and
(c) a disulfonated diphenyl component;
wherein the chealant component, the polyaspartic acid component, and the disulfonated diphenyl component are present in sufficient amounts so that when the composition treats a colorant delivery system containing deposits, the deposits are removed from the system.

2. The composition of claim 1, wherein the chealant component is sodium iminodisuccinate and the sodium iminodisuccinate is present in an amount ranging from 20 to 100 weight %, based on the total weight of the composition.

3. The composition of claim 1, wherein the polyaspartic component is polyaspartic sodium salt and the salt is present in an amount ranging from 0 to 50 weight %, based on the total weight of the composition.

4. The composition of claim 1, wherein the disulfonated diphenyl component is selected from the group consisting of sodium mono disulfonated diphenyl, didecyl disulfonated diphenyl, and combinations thereof, and the disulfonated diphenyl component is present in an amount ranging from 1 to 50, weight %, based on the total weight of the composition.

5. The composition of claim 1, wherein the composition has a pH ranging from 9 to 12.

6. The composition of claim 1, wherein the composition has a solids weight % ranging from 30 to 50 weight %, based on the total weight of the composition.

7. The composition of claim 1, wherein the composition has a specific gravity ranging from 1.25 to 1.5, based on the total weight of the composition.

8. The composition of claim 1, wherein the composition has a visual appearance of a clear amber colored liquid.

9. A method comprising:
(a) adding a sodium iminodisuccinate component to a vessel,
(b) adding, with stirring, a polyaspartic acid sodium salt component.
(c) adding, to the vessel, a disulfonated diphenyl component selected from the group consisting of sodium mono disulfonated diphenyl, didecyl disulfonated diphenyl, and combinations thereof; and
(d) stirring the mixture for a sufficient amount of time to mix the resulting mixture product is well mixed and uniform;
wherein the sodium iminodisuccinate component, the polyaspartic acid sodium salt component, and the disulfonated diphenyl component are present in sufficient amounts so that when the composition treats a colorant delivery system containing deposits, the deposits are removed from the system.

10. The method of claim 9, wherein the sodium iminodisuccinate component is added in an amount ranging from 20 to 100 weight %, based on the total weight of the composition.

11. The method of claim 9, wherein the polyaspartic acid sodium salt component is added in an amount ranging from 0 to 50 weight %, based on the total weight of the composition.

12. The method of claim 9, wherein the disulfonated diphenyl component is added in an amount ranging from 1 to 50 weight %, based on the total weight of the composition.

13. A method for cleaning a colorant delivery system comprising treating a colorant containing a colorant with a mixture comprising:
(a) a sodium iminodisuccinate component;
(b) a polyaspartic acid sodium salt component; and
(c) a disulfonated diphenyl component selected from the group consisting of sodium mono disulfonated diphenyl, didecyl disulfonated diphenyl,
and combinations thereof; and thereby removing deposits from the system.

14. The method of claim 13, wherein the sodium iminodisuccinate component is present in an amount ranging from 20 to 100, based on the total weight of the composition.

15. The method of claim 13, wherein the polyaspartic sodium salt component is present in an amount ranging from 0 to 50 weight %, based on the total weight of the composition.

16. The method of claim 13, wherein the disulfonated diphenyl component is present in an amount ranging from 1 to 50 weight %, based on the total weight of the composition.

17. The method of claim 13, wherein the composition has a pH ranging from 9 to 12.

18. The method of claim 13, wherein the composition has a solids weight % ranging from 30 to 50 weight %, based on the total weight of the composition.

19. The method of claim 13, wherein the composition has a specific gravity ranging from 1.25 to 1.50.

20. The method of claim 13, wherein the composition has a visual appearance of a clear amber colored liquid.

21. The method of claim 13, wherein the delivery system is a set of components that come in direct contact with a neat or diluted colorant.

22. The method of claim 13, wherein the colorant is selected from the group consisting of basic colorants, direct colorants, pigments, pigment dispersions, security colorants, and combinations thereof.

23. The delivery system of claim 13, wherein the delivery system is selected from the group consisting of metal piping, stainless steel components, filtering devices, valves, metering pumps, dilution tanks, and combinations thereof.

24. A composition comprising:
(a) a sodium iminodisuccinate component in an amount ranging from 20 to 100 weight %, based on the total weight of the composition; and
(b) a polyaspartic acid component in an amount ranging from more than 0 to 50 weight %, based on the total weight of the composition.
(c) a disulfonated diphenyl component, selected from the group consisting of sodium mono disulfonated diphenyl, didecyl disulfonated diphenyl,
and combinations thereof, in an amount ranging from 1 to 50, weight %, based on the total weight of the composition.
